(19) United States
(12) Patent Application Publication
(10) Pub. No.: US 2017/0204295 A1
(43) Pub. Date: Jul. 20, 2017

(54) METHOD FOR IMPROVIING DAMPENING PERFORMANCE OF THIN FILMS

(71) Applicant: 3M INNOVATIVE PROPERTIES COMPANY, St. Paul, MN (US)

(72) Inventors: Sunil K. Pillalamarri, Rosemount, MN (US); Robert C. Fitzer, North Oaks, MN (US)

(73) Assignee: 3M INNOVATIVE PROPERTIES COMPANY, Saint Paul, MN (US)

(21) Appl. No.: 15/328,197

(22) PCT Filed: Jul. 22, 2015
(86) PCT No.: PCT/US2015/041595

§ 371 Date: Jan. 23, 2017

Related U.S. Application Data
(60) Provisional application No. 62/028,859, filed on Jul. 25, 2014.

(51) Int. Cl. C09J 7/02; B32B 5/18; B32B 7/12; B32B 27/40; B32B 3/30; C08J 5/18; B32B 27/32

(52) U.S. Cl. CPC C09J 7/0232; C08J 5/18; B32B 5/18; B32B 27/32; B32B 27/40; B32B 3/30; B32B 7/12; C09J 2423/005; C09J 2467/005; C08J 2323/06; C08J 2367/02; B32B 2266/08; B32B 2266/06

(57) ABSTRACT

A dampening structure includes a polymer layer having a first surface and a second surface. The first surface includes a plurality of micro-structures, wherein each of the micro-structures has a width of less than about 400 microns. An elastic modulus of the polymer layer is greater than about 0.1 MPa and less than about 5 GPa at 25° C. The polymer layer is non-tacky.

### FIELD OF THE INVENTION

The present invention is generally related to micro-structured thin films. In particular, the present invention relates to micro-structured thin films that provide improved dampening performance.

### BACKGROUND

As electronic devices (e.g., mobile phones and tablets) become increasing thinner, the dampening layers that provide drop and shock absorption must typically be less than about 20 millimeters in thickness. In applications requiring sound, vibration and shock absorption the dampening layers can be made of foams based on different chemistries, such as polyurethanes, polyolefins and acrylics. The dampening performance of these foams is strongly dependent on the chemistry as well as the size and type of cell structures of the foam. With the increasing demand for thinner display devices and thinner bond lines, the foams are required to offer similar or better cushioning characteristics at lower thickness values.

Current dampening layers are based on either open or closed cell foams of acrylic, polyolefin, natural or synthetic elastomers or polyurethanes. The gas in the foam cell structures helps in absorbing the stress generated during different mechanical processes. However, large cell volumes (typically around 30-40 vol %) are required to offer the required levels of stress absorption. With increasing emphasis on reducing display thickness, the thickness of damping layers has been reduced to less than 200 μm. Foams at these thickness values can suffer from multiple disadvantages in process handling and reworkability, due to poor cohesive strength.

### SUMMARY

In one embodiment, the present invention is a dampening structure including a polymer layer having a first surface and a second surface. The first surface includes a plurality of micro-structures, wherein each of the micro-structures has a width of less than about 400 microns. An elastic modulus of the polymer layer is greater than about 0.1 MPa and less than 5 GPa at 25 C. The polymer layer is non-tacky.

In another embodiment, the present invention is a dampening structure including a polymer layer and a sealing layer. The polymer layer has a first and a second surface. At least one of the surfaces includes a plurality of topographical features having discrete cavities. The sealing layer is positioned adjacent to the surface comprising the plurality of topographical features. The sealing layer seals at least a portion of the cavities, entrapping gas therein.

### BRIEF SUMMARY OF THE FIGURES

FIG. 1A is a cross-sectional view of a formed construction including a first embodiment of a dampening structure of the present invention.

FIG. 1B is a cross-sectional view of the first embodiment of the dampening structure of the present invention.

FIG. 1C is a top view of the first embodiment of the dampening structure of the present invention.

FIG. 2A is a cross-sectional view of a formed construction including a second embodiment of a dampening structure of the present invention.

FIG. 2B is a cross-sectional view of a second embodiment of the dampening structure of the present invention.

FIG. 3A is a cross-sectional view of a formed construction including a third embodiment of a dampening structure of the present invention.

FIG. 3B is a cross-sectional view of a third embodiment of the dampening structure of the present invention.

FIG. 4A is a cross-sectional view of a formed construction including a fourth embodiment of a dampening structure of the present invention.

FIG. 4B is a cross-sectional view of a fourth embodiment of the dampening structure of the present invention.

FIG. 5A is a cross-sectional view of a formed construction including a fifth embodiment of a dampening structure of the present invention.

FIG. 5B is a cross-sectional view of a fifth embodiment of the dampening structure of the present invention.

FIG. 5C is a cross-sectional view of the fifth embodiment of the dampening structure of the present invention.

FIG. 5D is a top view of the fifth embodiment of the dampening structure of the present invention with a sealing layer.

These figures are not drawn to scale and are intended merely for illustrative purposes.

### DETAILED DESCRIPTION

The dampening structure of the present invention improves the dampening performance or shock absorbance of thin layers, such as films and/or foams. The dampening structure includes a polymer layer having a first surface and a second, opposing surface. Micro-structured cavities, e.g. channels or pockets, and/or protrusions (collectively micro-structures) are incorporated on at least one of the first and second surfaces of the polymer layer and function to improve product handling due to their dampening effect. The micro-structures provide a topographical surface and are an alternate route to foaming to increase the air volume in the polymer layer without significantly affecting the mechanical properties of the polymer layer. In addition to improved shock absorbance, the microstructures, i.e. dampening structures, of the present invention have improved repositionability, surface wetting, layer application and handling. Also, the shape and dimensions of the micro-structured polymer layer offers the ability to modify the amount local pressure in the micro-structured elements during lamination.

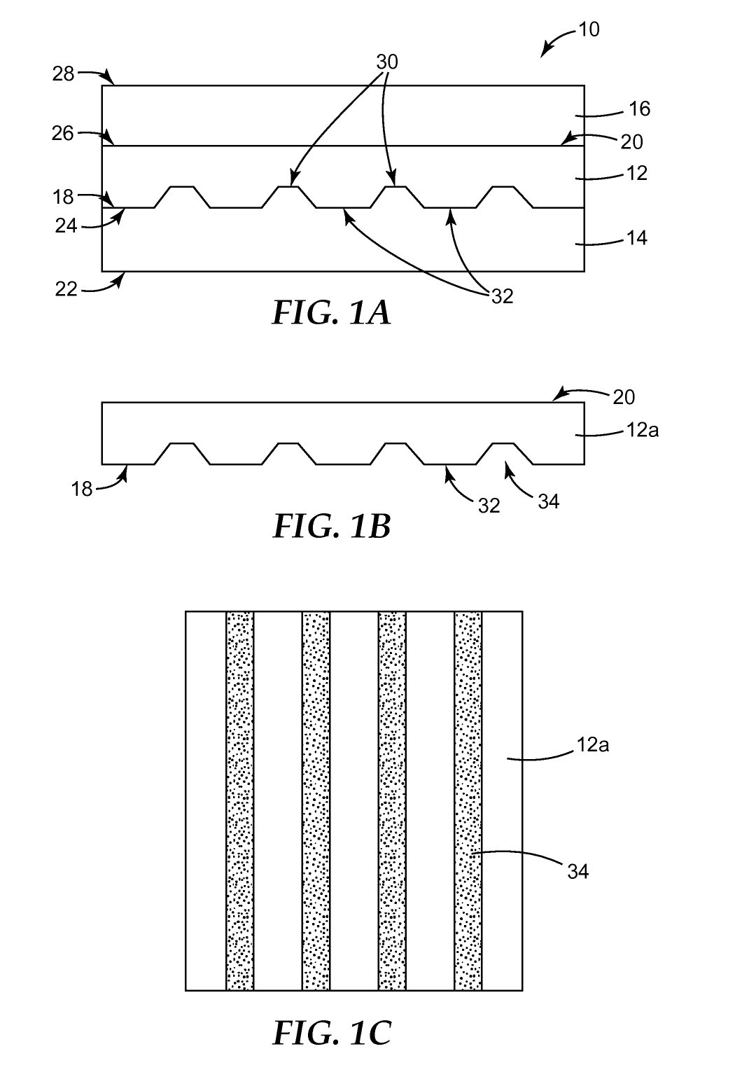

FIG. 1A shows a cross-sectional view of a formed construction of a first embodiment of a dampening structure 10 of the present invention including a polymer layer 12, a micro-structured liner 14 and a release liner 16. The polymer layer 12 includes a first surface 18 and a second surface 20, the micro-structured liner 14 includes a first surface 22 and a second surface 24, and the release liner 16 includes a first surface 26 and a second surface 28. After removal of the liners 14, 16 from the polymer layer 12, the polymer layer 12 becomes a micro-replicated layer and acts as a dampening layer. The improved dampening property is a result of the topographical surface of the micro-structured liner 14.

The polymer layer 12 may be any non-tacky polymer layer that is substantially free of inorganic particles that have a Mohs hardness of less than about 5, and particularly less than about 3. Substantially free of inorganic particles means less than about 5%, particularly less than about 3% and more particularly less than about 1% inorganic particles. In some embodiments, the polymer layer 12 does not include inorganic particles. The polymer layer 12 has a peak in the Tan delta of at least about 0.3, particularly at least about 0.5 and more particularly at least about 0.7, when measured by dynamical mechanical thermal analysis (DMTA). The DMTA tests may be conducted using any conventional DMTA methods. The DMTA may be conducted using a tensile mode configuration. The frequency employed can be from 0.1 to 1,000 Hz, 1 Hz being typical. The DMTA scan may be conducted over a temperature range of about at least 40° C. above and 40° C. below the peak in Tan delta, wherein the temperature increase during the DMTA may be selected in a range of from about 0.1 degrees C./min to about 10 degrees C./min. The thickness of the polymer layer 12 for testing may be in the range of about 50 microns to about 5 mm. The width of the sample may be in the range of about 1 mm to about 10 mm. The gauge length may be in the range of about 10 mm to 30 mm. The strain of the sample during testing may be in the range of about 0.01 to 2 times of the gauge length.

In one embodiment, the polymer layer 12 has an elastic modulus at 25° C. of about of about 0.01 MPa, or greater, 0.1 MPa or greater, 0.5 MPa or greater or even 1 MPa or greater. The elastic modulus may be about 5 GPa or less, about 1 GPa or less or even about 0.5 GPa or less. The polymer layer 12 may be a film or a foam. Examples of suitable polymers include, but are not limited to: acrylics, polyolefins, natural or synthetic elastomers and polyurethanes. Polyurethanes are particularly suitable as the polymer layer. The polymer layer 12 may optionally contain materials with functionality to improve electrical conductivity, thermal conductivity, electromagnetic interference (EMI) shielding, EMI absorption, or a combination thereof. In some embodiments, the polymer layer 12 and/or adhesive layer(s), when present, may include at least one of electrically conductive particles and an electrically conductive interconnected layer. In some embodiments, the polymer layer 12 and/or adhesive layer(s), when present, may include at least one of thermally conductive particles or a thermally conductive interconnected layer. In some embodiments, the polymer layer 12 and/or adhesive layer(s), when present, may include at least one of EMI absorbing particles, EMI shielding particles, an EMI absorbing interconnected layer and an EMI shielding interconnected layer. The cavities and/or protrusions formed on the surface of the polymer layer 12 dissipate stress by allowing air to bleed through the layer. The shape and dimensions of the cavities and/or protrusions are controlled by varying the topographical surface of the micro-structured liner 14. The topography of the first surface 18 of the polymer layer 12 will have the inverse topography of the micro-structured liner 14.

The second surface 24 of the micro-structured liner 14 includes topography created by a plurality of features 30 having shapes and dimensions which correspondingly create the cavities and/or protrusions (microstructures 32) in the polymer layer 12. The topography may include features such as protrusions and/or cavities interconnected in at least one dimension in the x, y plane of at least one of its major surfaces, and preferably, in at least two dimensions. In this case, the corresponding formed microstructures 32 of the polymer layer 12, having the inverse microstructure 30 of the micro-structured liner 14, may be channels allowing for air bleed. If the micro-structured liner 14 includes topography that includes only discrete protrusions, the corresponding formed microstructures 32 of the polymer layer 12 may be discrete cavities or pockets that allow for the entrapment of a fluid, e.g. a gas. The shape and size of these protrusions and/or cavities can be regular or irregular across the topographical surface of the structured liner. Likewise, the interconnection can follow a regular or irregular pattern in at least one dimension in the x, y plane of least one of the major surfaces of the structured liner. All of the key dimensions, e.g. height, width, shape and spacing, of the micro-structured features 30 of the micro-structured liner 14 are selected based on the final topography desired in the surface of the polymer layer. In one embodiment, each of the features 30 has a height of between about 5 and 200 microns and particularly between about 5 and 25 microns and a width of between about 15 and about 400 microns particularly between about 50 and about 300 microns. In another embodiment, each of the features 30 has a height/depth of between about 10 and about 200 microns particularly between about 25 microns and about 75 microns. In one embodiment, the center distance between the respective protrusions or the respective cavities is between about 20 and about 500 microns particularly between about 20 and about 100 microns. In one embodiment, for a 100 micron thick polymer layer, the features have a height of between 20 and 50 microns. In another embodiment, for a 100 micron thick polymer layer, the features have a height of between 30 and 45 microns.

The topographical surface of the micro-structured liner 14 may include any shaped features known to those of skill in the art without departing from the intended scope of the present invention. For example, the micro-structured features 30 of the micro-structured liner 14 may include, but are not limited to: posts, pyramids, trapezoids, channels, etc. In addition, the micro-structures do not have to be arranged in a regular or repeating pattern, such as lines or a cross pattern. The micro-structures 30 may also be in a random pattern. In one embodiment, the micro-structures 30 create channels, pockets, or combinations thereof.

In the embodiments of the present invention, a micro-structured polymer layer, i.e. a micro-structured polymer layer, is produced. In a first embodiment shown in FIG. 1A, a micro-structured polymer layer 12 having a first micro-structured surface 18 and a second surface 20 is shown with a micro-structured liner 14 adjacent to the first surface 18 of the polymer layer 12 and a second release liner 16 adjacent the second surface 20 of the polymer layer 12. As previously mentioned, the second surface 24 of the micro-structured liner 14 includes a micro-structured surface having a plurality of topographical features 30. In this embodiment, the micro-structured surface 24 includes a plurality of truncated pyramid shapes extending along a length of the micro-structured liner 14. During fabrication, the micro-structured surface 24 of the micro-structured liner 14 is placed in contact with a polymer precursor, the pattern of the micro-structured surface 24 is transferred to the polymer precursor. Upon curing of the polymer precursor, the polymer layer 12 is formed and a micro-structured surface 18 is produced in the polymer layer 12, the micro-structured surface 18 being the inverse of the micro-structured surface 24 of the micro-structured liner 14. The contact of the micro-structured surface 24 of the micro-structured liner 14 with the formed polymer creates land regions and cavities and/or protrusions. In some embodiments, when the cavities and/or protrusions form channels, a polymer layer 12 is produced having a micro-structured surface 18 that allows for air bleed.

FIGS. 1B and 1C show a cross-sectional view and a top view, respectively, of the formed micro-structured polymer layer 12a after the liners 14, 16 have been removed. As can be seen, once the micro-structured liner 14 is removed from the polymer layer 12, channels 34 are incorporated on the first surface 18 of the polymer layer 12, allowing for air bleed.

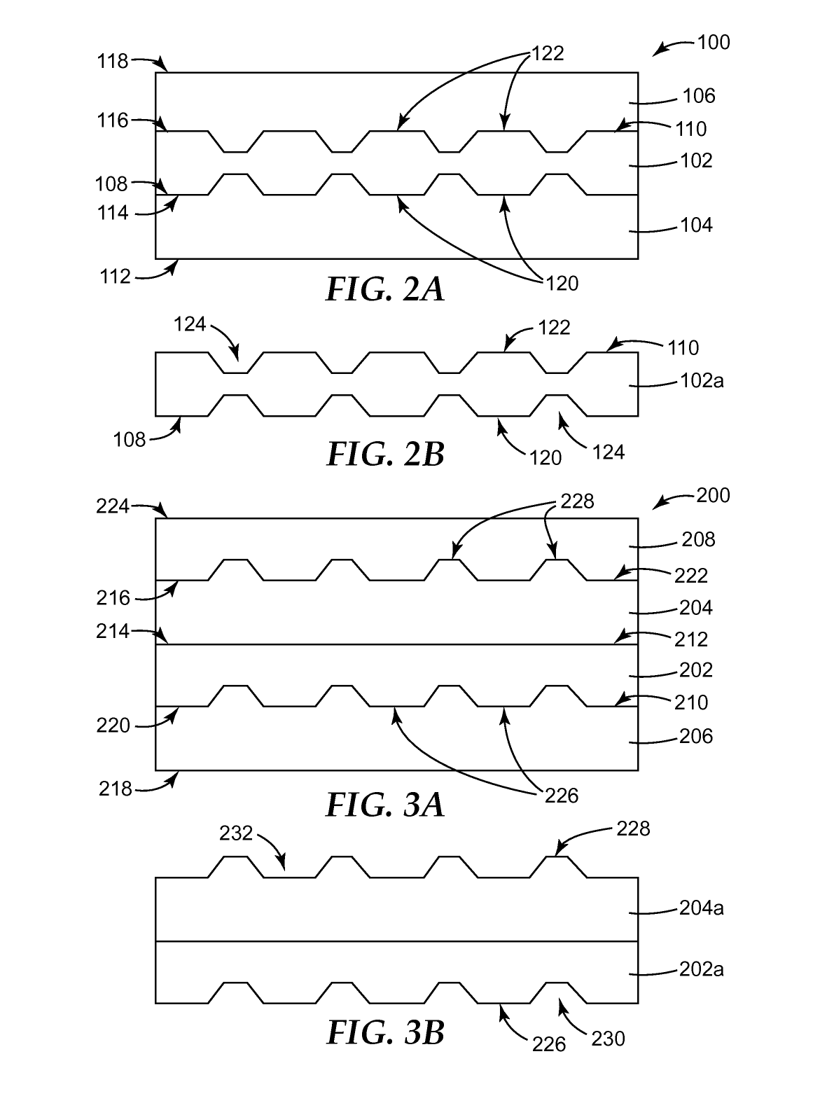

FIG. 2A shows a cross-sectional view of a second embodiment of a formed construction of a dampening structure 100 of the present invention including a polymer layer 102, a first micro-structured liner 104 and a second micro-structured liner 106. The polymer layer 102 and first micro-structured liner 104 of the second embodiment are similar in properties and functionality to the polymer layer 12 and the micro-structured liner 14 of the first embodiment. The second micro-structured liner 106 is similar in properties and functionality to the first micro-structured liner 104 with the micro-structured surface 116 of the second micro-structured liner 106 being positioned adjacent to a second surface 110 of the polymer layer 102. In this embodiment, the topographical surface 116 of the second micro-structured liner 106 is the same as the topographical surface 114 of the first micro-structured liner 104. In the embodiment of FIG. 2A, the micro-structures 120 of the first surface 106 of the polymer layer 102 are the same as the micro-structures 122 of the second surface 110 of the polymer layer 102. In other embodiments, the topographical surface of the second micro-structured liner 106 may be different from the topographical surface of the first micro-structured liner 104. In these embodiments, the micro-structures of the first surface 106 of the polymer layer 102 are different from the micro-structures of the second surface 110 of the polymer layer 102. FIG. 2B shows a cross-sectional view of the micro-structured polymer 102a layer after the liners 104, 106 have been removed. As can be seen in FIG. 2B, once the liners 104, 106 are removed, the polymer layer 102a includes channels 124 on both the first and second surfaces 108, 110, allowing for air bleed along both surfaces.

FIG. 3A shows a cross-sectional view of a third embodiment of a formed construction of a dampening structure 200 of the present invention. The formed construction includes a polymer layer 202, a pressure sensitive adhesive 204, a first micro-structured liner 206 and a second micro-structured liner 208. The polymer layer 202 and first micro-structured liner 206 of the third embodiment are similar in properties and functionality to the polymer layer 12, 102 and the micro-structured liner 14, 104 of the first and second embodiments. The second micro-structured liner 208 is also similar in properties and functionality as the second micro-structured liner 106 of the second embodiment, except that the first surface 222 of the second micro-structured liner 208 is positioned adjacent a second surface 216 of the pressure sensitive adhesive 204. The first surface 214 of the pressure-sensitive adhesive 204 is positioned adjacent a second surface 212 of the polymer layer 202. In the embodiment of FIG. 3A, the topographical surface 222 of the second micro-structured liner 208 is different from the topographical surface 220 of the first micro-structured liner 206. In this embodiment, the micro-structures 226 of the first surface 210 of the polymer layer 202 are different from the micro-structures 228 of the second surface 220 of the pressure sensitive adhesive 204. In other embodiments, the topographical surface of the second micro-structured liner 208 may be the same as the topographical surface of the first micro-structured liner 206. In these embodiments, the micro-structures of the first surface 210 of the polymer layer 202 are the same as the micro-structures of the second surface 216 of the pressure sensitive adhesive 204.

FIG. 3B shows a cross-sectional view of the micro-structured polymer layer and micro-structured pressure sensitive adhesive laminate after the liners 206, 208 have been removed. As can be seen in the figure, once the liners 206, 208 have been removed, the polymer layer 202a and the pressure sensitive adhesive 204a now include micro-structured surfaces, creating channels 230, 232 to allow for air bleed along the exposed surfaces.

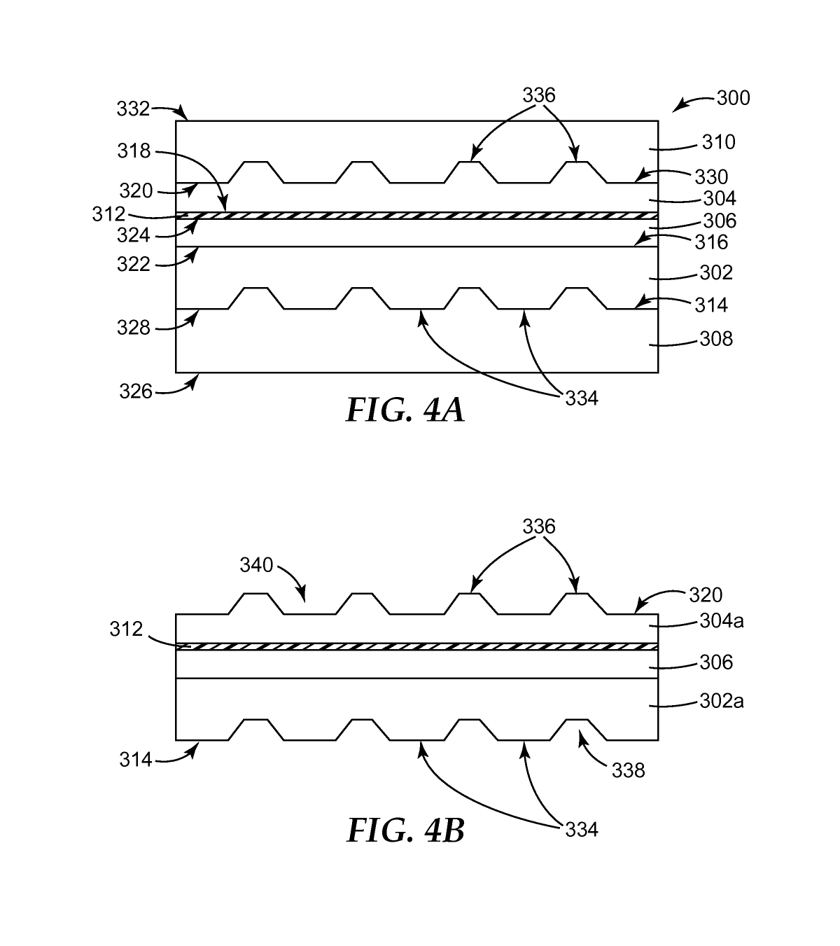

A fourth embodiment of a dampening structure 300 of the present invention is similar to the third embodiment of the micro-replicated structure except that in the fourth embodiment, as shown in cross-sectional views in FIGS. 4A and 4B, the dampening structure 300 includes a first pressure sensitive adhesive and a second adhesive. The fourth embodiment includes a polymer layer 302, a first pressure sensitive adhesive 304, a second adhesive 306, first micro-structured liner 308 and a second micro-structured liner 310. In one embodiment, the second adhesive 306 may be a pressure sensitive adhesive. In one embodiment, the dampening structure 300 may optionally include a plastic backing or core 312 positioned between the pressure sensitive adhesives 304, 306. The polymer layer 302, first pressure-sensitive adhesive 304, first micro-structured liner 308 and second micro-structured liner 308 of the fourth embodiment are similar in properties and functionality to the polymer layer 202, first pressure-sensitive adhesive 204, first micro-structured liner 206 and second micro-structured liner 208 of the third embodiment. However, in the fourth embodiment, the second adhesive 306 is positioned between the polymer layer 302 and the first pressure-sensitive adhesive 304. A second surface 324 of the second adhesive 306 is positioned adjacent a first surface 318 of the first micro-structured pressure sensitive adhesive 304 and a first surface 322 of the second adhesive 306 is positioned adjacent a second surface 316 of the polymer layer 302. In the embodiment of FIG. 4A, the topographical surface 330 of the second micro-structured liner 310 is different from the topographical surface 328 of the first micro-structured liner 308. In this embodiment, the micro-structures 334 of the first surface 314 of the polymer layer 302 are different from the micro-structures 336 of the second surface 320 of the first pressure sensitive adhesive 304. In other embodiments, the topographical surface of the second micro-structured liner 310 may be the same as the topographical surface of the first micro-structured liner 308. In these embodiments, the micro-structures of the first surface 314 of the polymer layer 302 are the same as the micro-structures of the second surface 320 of the first pressure sensitive adhesive 304. As can be seen in FIG. 4B, after the liners 308, 310 are removed, the polymer layer 302a and the first pressure sensitive adhesive 304a each include a micro-replicated surface 314, 320 where the micro-structured liners 308, 310 were previously positioned. The micro-replicated surfaces 314, 320 create channels 338 and 340 on the first surface 314 of the polymer layer 302a and the second surface 324 of the first micro-structured pressure sensitive adhesive 304a, respectively, allowing for air bleed along both surfaces. The fourth embodiment includes the second adhesive 306 positioned between the micro-structured polymer layer 302a and the first micro-structured pressure sensitive adhesive 304a.

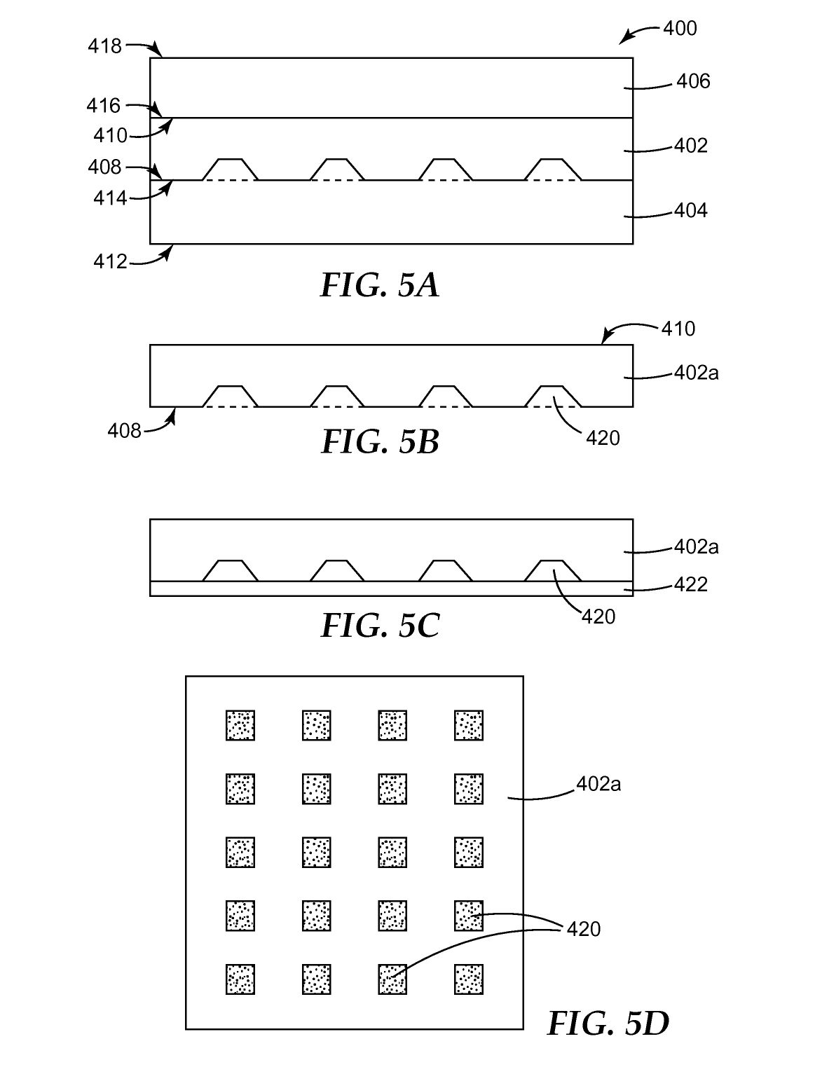

FIGS. 5A, 5B, 5C and 5D show a fifth embodiment of a dampening structure 400 of the present invention. As shown in FIG. 5A, the dampening structure 400 includes a polymer layer 402, a micro-structured liner 404 positioned adjacent to a first surface 408 of the polymer layer 402 and a release liner 406 positioned adjacent to a second surface 410 of the polymer layer 402. The polymer layer 402, micro-structured liner 404 and release liner 406 of the fifth embodiment are similar in functionality to the polymer layer 12, micro-structured liner 14 and release liner 16 of the first embodiment, except that in the fifth embodiment, the polymer layer 402 may be made of foam and the micro-structured surface 408, which is the inverse the topographical surface 414 of the micro-structured liner 404, includes a plurality of individual and discrete, square, truncated pyramid-like shaped protrusions. Thus, as can be seen in the cross-sectional view of FIG. 5B and the top view of FIG. 5C, after the liners 404, 406 are removed, the polymer layer 402a includes a first micro-structured surface 408 having discrete pockets, or cavities, on the first surface 408 of the polymer layer 402a. Although discrete, square, truncated pyramid-like shaped protrusions are shown in FIG. 5, discrete cavities of any known shape in the art may be used.

The pockets 420 allow air to be trapped within the micro-structured polymer layer 402a when a sealing layer 422, shown in FIG. 5D, is positioned against the first surface 408 of the micro-structured polymer layer 402a. In one embodiment, the thickness of the sealing layer 422 is less than a depth of the pockets 420 in the micro-structured polymer layer 402a. In one embodiment, the sealing layer 422 is a plastic film known to those of skill in the art. For example, the plastic film may be a polyester, such as polyethylene terephthalate, a polyolefin, such as polyethylene and polypropylene, or a polyamide, such as nylon 6, nylon 6,6 and nylon 6,12, polycarbonate and the like.

In one embodiment, the micro-structured surfaces of the dampening structures of the present invention are formed by preparing a curable polymeric precursor and coating the precursor between release liners. At least one of the release liners includes a micro-structured surface having the inverse surface of the desired surface on the polymer layer. After coating, the precursor is cured via heat or actinic radiation (e.g. UV radiation), to form the polymer layer. However, if a soft thermoplastic polymer or thermoplastic elastomer is used, a heat (above the glass transition temperature or softening temperature) and pressure (greater than 1 pound per lineal inch (PLI) embossing process may be used to form the micro-structured surface of the polymer layer. Additionally, if the pressure-sensitive adhesive is cast out of a solvent solution which is subsequently dried in a thermal oven, the dried pressure-sensitive adhesive will take on the micro-structured image.

### EXAMPLES

The present invention is more particularly described in the following examples that are intended as illustrations only, since numerous modifications and variations within the scope of the present invention will be apparent to those skilled in the art. Unless otherwise noted, all parts, percentages, and ratios reported in the following example are on a weight basis.

### Materials

Materials

| Abbreviation | |
|---|---|
| or | |
| Trade Name | Description |
| RL1 | A conventional (no micro-structured surface) release liner |
| | with an acrylic release coating. |
| RL2 | A conventional (no micro-structured surface) silicone |
| | release liner having a matte finish available as “MTHLK |
| | 300 GAUGE RELEASE LINER” from Mitsubishi |
| | Polyester Films GmbH, a division of Mitsubishi Plastics, |
| | Inc., Greer, South Carolina. |
| Rubinate | Uretonomine modified polyether pre-polymer, available as |
| 1670 | “RUBINATE 1670 ISOCYANATE” from Huntsman |
| | International, LLC, Salt Lake City, Utah. |
| Carpol | Glycerine initiated polyether polyol having a functionality |
| GP-1000 | of three and an average molecular weight of 1000, |
| | available as “CARPOL GP-1000” from Carpenter, |
| | Richmond, Virginia. |
| Carpol | Glycerine initiated polyether polyol having a functionality |
| GP-700 | of three and an average molecular weight of 700, available |
| | as “CARPOL GP-700” from Carpenter. |
| Fyrol HF-5 | Halogen-free polymeric/oligomeric phosphorus ester |
| | flame retardant available as “FYROL HF-5” from ICL-IP |
| | America Inc., St. Louis, Missouri, a subsidiary of ICL |
| | Industrial Products, Isreal. |
| REPI | Black pigment, available as “REPI 90332 Black” from |
| 90332 Black | Repi LLC, Charlotte, North Carolina, a subsidiary of Repi |
| | S.p.A, Milan, Italy. |
| Bicat 8210 | Polyurethane catalyst, a bismuth carboxylates mixture with |
| | about 28% bismuth, available as “BICAT 8210”, from |
| | Shepherd Chemical Company, Norwood, Ohio. |
| Bicat Z | Polymerization catalyst, a zinc carboxylate mixture with |
| | about 19% zinc, available as “BICAT Z”, from Shepherd |
| | Chemical Company. |

### Test Methods, Preparation Procedures

### Preparation of Micro-Structured Release Liner 1 (MSRL1)

MSL1 was prepared by a conventional micro-embossing technique, see for example U.S. Pat. No. 6,524,675 (Mikami, et. al.) and U.S. Pat. No. 6,759,110 (Flemming, et. al.) which are incorporate herein in their entirety by reference. The release liner was embossed to form patterns of protruding ridges on the front side surface. The liners generally had about 125 micron thick paper core, about a 25 micron thick polyethylene with a matte finish on the back side, about a 25 micron thick polyethylene with a glossy finish on the front side, and a commercial silicone coating on the glossy polyethylene side. The pattern was formed under heat and pressure using an engraved embossing tool. The final pattern embossed in the liner was an array of two sets of intersecting parallel ridges forming a square grid array of cavities oriented 45 degrees from the axis of the tool. The ridges had a trapezoidal cross-section shape. The base of the trapezoid was about 130 microns in length and the top of the trapezoid was about 26 microns in length. The angles between the two interior sidewalls of the trapezoid and the base were both about 30°. The height of the trapezoid was about 30 microns. The lineal density of the trapezoidal cross-section shaped ridges was about 15 lines per inch, yielding a repeat pitch (center to center distance between ridges) of about 1693 microns. The embossing tool used to create this liner pattern had the inverse of this pattern.

### Preparation of Micro-Structured Release Liner 2 (MSRL2)

MSL2 was prepared similar to MSL1, except the feature dimensions were different. MSL2 had a square grid array of truncated, square pyramid shaped cavities oriented 45 degrees from the axis of the embossing tool. These cavities created a corresponding array of intersecting linear ridges, the linear ridges being perpendicular to one another. The pyramid top, which protruded into the liner and represented the bottom of the cavity, was about 2 microns in length. The pyramid base was about 286 microns and the pyramid height (depth) was about 25 microns. The lineal density of the truncated, square pyramid shaped cavities was about 87 per inch, yielding a repeat pitch (center to center distance between cavities) of about 292 microns and a corresponding space between cavities of about 6 microns. The embossing tool used to create this liner pattern had the inverse of this pattern.

### Micro-Structured Release Liner 3 (MSRL3)

MSL3 was a commercially available liner available under the trade designation 83703BE available from 3M Korea, LTD., Seoul, South Korea. 83703BE was a double side pressure sensitive adhesive (psa) transfer tape having black PET as the core substrate and dual release liners adjacent the psas. One of the psa's major surfaces had a micro-structured surface, corresponding to the inverse micro-structure of the adjacent release liner. The other Acrylic psa had a substantially flat major surface corresponding to the substantially flat major surface of the adjacent release liner.

### Examples 1-3 and Comparative Example 5 (CE-5)

A polyol premix was prepared by mixing 75 parts by weight (pbw) Carpol GP-1000, 25 pbw Carpol GP-700, 9.5 pbw Fyrol HF-5, 2.0 pbw REPI 90332 Black, 0.1 pbw Bicat 8210 and 0.2 pbw Bicat Z. The components were placed in a DAC cup, available from FlackTek Inc., Landrum, S.C., and mixed using a Hauschiid SPEEDMIXER DAC 400 FVZ, available from FlackTek Inc., operating at 2100 rpm for 2 minutes.

An isocyanate premix was made prepared from 90 pbw Rubinate 1670 and 10.5 pbw Fyrol HF-5. The components of the isocyanate premix were mixed as described above.

The two premix solutions were combined by using 2 parts by volume of the polyol premix and 1 part by volume of the isocyanante premix into a syringe having a static mixer. The liquid was dispensed from the syringe through the mixer forming a reactive polyurethane precursor solution.

Polyurethane thin films were made by knife coating the polyurethane precursor between the appropriate release liners (see Table 1). In all the examples and the comparative example, the polyurethane precursor was coated at a 5 mil (127 micron) thickness. The polyurethane precursor was then cured at 170° F. for 2 minutes, yielding a tack free polyurethane film. All the Examples, except Comparative Example 5, had at least one major surface having a micro-structured surface, produced via the coating process and corresponding adjacent micro-structured liner surface. The micro-structured surface of the polyurethane film was the inverse structure of that of the micro-structured release liner. When MSRL3 was used as the top liner, the release liner (of the as received double sided tape) adjacent micro-structured psa surface was removed, prior to coating. The polyurethane precursor was then coated such that it was adjacent to the micro-structured psa surface of MSRL3.

### Example 4

Example 4 was prepared similarly to Examples 1-3, except the bottom release liner was MSRL3 and the top release liner was MSRL1. In this case, the release liner (of the as received double sided tape MSRL3) adjacent the substantially flat surface was removed from MSRL3. When coated, the polyurethane precursor was coated adjacent the substantially flat surface of the psa of MSRL3 and the micro-structured surface of MSRL1. After curing the polyurethane precursor, the polyurethane film consisted of a laminate construction including one major surface of the micro-structured polyurethane (the surface that was adjacent to micro-structured surface of MSRL1) and the other major surface was the micro-structured surface of the psa of MSRL3. The construction still includes release liners that are in contact with the two outer major surfaces of the laminate (micro-structured polyurethane and micro-structured psa), the release liners can be removed prior to use.

Examples 1 and 2 produced polyurethane films that included one major surface being micro-structured. Examples 3 and 4 produced polyurethane films that included both major surfaces being micro-structured. Comparative Example 5 had no micro-structured surfaces. The constructions still includes release liners that are in contact with the two outer major surfaces of the polyurethane film, the release liners can be removed prior to use.

TABLE 1

| Example | Top Liner | Bottom Liner |
|---|---|---|
| 1 | MSRL1 | RL2 |
| 2 | MSRL2 | RL2 |
| 3 | MSRL1 | MSRL1 |
| 4 | MSRL3 | MSRL1 |
| CE-5 | RL1 | RL2 |

Although the present invention has been described with reference to preferred embodiments, workers skilled in the art will recognize that changes may be made in form and detail without departing from the spirit and scope of the invention.

1. A dampening structure comprising:
a polymer layer having a first surface and a second surface, wherein the first surface comprises a plurality of micro-structures and wherein each of the micro-structures has a width of less than about 400 microns; and
wherein an elastic modulus of the polymer layer is greater than about 0.01 MPa and less than about 5 GPa at 25° C., and wherein the polymer layer is non-tacky.

2. The dampening structure of claim 1, wherein the plurality of micro-structures comprise protrusions, cavities or combinations thereof.

3. The dampening structure of claim 2, wherein the protrusions and cavities are discrete, continuous or combinations thereof.

4. The dampening structure of claim 1, wherein the micro-structures form continuous cavities extending along an entire length of the dampening layer within the plane of the first surface.

5. The dampening structure of claim 1, wherein the polymer layer is a polymer selected from the group consisting of: acrylics, polyolefins, natural or synthetic elastomers and polyurethanes.

6. The dampening structure of claim 1, wherein the polymer layer is a solid film.

7. The dampening structure of claim 1, wherein the polymer layer is a foam.

8. The dampening structure of claim 7, wherein the polymer layer is one of an open cell foam or a closed cell foam.

9. The dampening structure of claim 1, wherein the second surface also comprises a plurality of micro-structures and wherein each of the micro-structures has a width of less than about 400 microns.

10. The dampening structure of claim 1, further comprising a first pressure sensitive adhesive layer having a first surface and a second surface, wherein the second surface of the polymer layer is positioned adjacent to the second surface of the pressure sensitive adhesive layer and wherein the first surface of the first pressure sensitive adhesive layer comprises a plurality of micro-structures.

11. The damping structure of claim 10, further comprising a second pressure sensitive adhesive positioned between the polymer layer and the first pressure sensitive adhesive.

12. The damping structure of claim 1, wherein the polymer layer is substantially free of inorganic particles having a Mohs hardness greater than about 5.

13. A dampening structure comprising:
a polymer layer having a first and a second surface, wherein at least the first surface comprises a plurality of topographical features having discrete cavities; and
a sealing layer positioned adjacent to the first surface comprising the plurality of topographical features, wherein the sealing layer seals at least a portion of the cavities, entrapping gas therein.

14. The dampening structure of claim 13, wherein the first and second surfaces comprise a plurality of topographical features.

15. The dampening structure according to claim 13, further comprising a pressure sensitive adhesive layer having a first surface and second surface, wherein the second surface of the substrate is adhered to the second surface of the pressure sensitive adhesive layer and the first surface of the pressure sensitive adhesive layer comprises a plurality of topographical features.

16. The dampening structure of claim 1, further comprising at least one of electrically conductive particles and an electrically conductive interconnected layer.

17. The dampening structure of claim 1, further comprising at least one of thermally conductive particles and a thermally conductive interconnected layer.

18. The dampening structure of claim 1, further comprising at least one of EMI absorbing particles, EMI shielding particles, an EMI absorbing interconnected layer and an EMI shielding interconnected layer.

19. The dampening structure of claim 13, further comprising at least one of electrically conductive particles, an electrically conductive interconnected layer, thermally conductive particles and a thermally conductive interconnected layer.

20. The dampening structure of claim 13, further comprising at least one of EMI absorbing particles, EMI shielding particles, an EMI absorbing interconnected layer and an EMI shielding interconnected layer.
